(19) United States
(12) Patent Application Publication
(10) Pub. No.: US 2007/0217765 A1
(43) Pub. Date: Sep. 20, 2007

(54) Method and its application for video recorder and player

(76) Inventors: Masaya Itoh, Hitachi (JP); Hiromasa Fujii, Yokohama (JP); Masahiro Kiyohara, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/654,673

(22) Filed: Jan. 18, 2007

(30) Foreign Application Priority Data
Mar. 9, 2006 (JP) 2006-064484

(51) Int. Cl. H04N 5/00

(52) U.S. Cl. 386/117

(57) ABSTRACT

In a video recorder/player that increases a frame rate for only a channel in which an event occurs in images captured by a plurality of cameras and which performs event analysis with higher accuracy within limited processing resources and limited storage capacity, the channel in which the event occurs is set as an event CH and normal channels are set as normal CH. When any event occurs, a processing is divided in accordance with a situation at that time into a frame rate changing processing of the event CH, a frame rate changing processing of the normal CH and the event CH and a changing processing that changes the frame rate of the event CH within a possible range.

### BACKGROUND OF THE INVENTION

This invention relates to a video recording/playback system used in an image surveillance system. More particularly, the invention relates to an apparatus, and a method, for recording and playing back images that can detect an event such as a motion of a person inside images captured.

To prevent crimes and to conduct criminal investigation, surveillance by guards with eye through monitor operations has been carried out in recent years in financial institutions and retail industry by installing a large number of cameras (television cameras) for surveillance in shop front. A surveillance system that uses a video recorder and player such as a video recorder has widely been used to store images inputted from the plurality of cameras so that the images taken can be later confirmed and the image contents can be analyzed, whenever necessary.

In the case of such a surveillance system, the images of each camera is serially acquired and recorded by cyclically turning a plurality of cameras at a predetermined frame rate. Therefore, this system needs a video recorder and player in which image input by a plurality of cameras is possible and an enormous amount of image data can be recorded. However, an efficient operation is indispensable because processing resources are limited at this time and the storage capacity of a recording medium is limited, too.

Moreover, because a desired image must be confirmed from among the enormous recording data in such a surveillance system, the video recorder and player used for this system must have the function of retrieving an event occurring in the image and selectively playing back the image containing the event as its important function.

Possible means for satisfying these requirements include a method that compresses the image data inputted, a method that controls recording by an external trigger and a method that executes indexing at the time of confirmation by using an external trigger as a retrieving tag, for example. In addition to an external sensor for acquiring the external trigger at this time such as an infrared sensor, there is a method that senses an event in the image such as a motion by image processing, and the function of changing a recording method by such an external trigger has widely been employed in the past.

As a related technology to the invention, a method that starts recording when the event is detected is known (refer to JP-A-2002-118822, for example), and an image surveillance system having means for changing a frame rate and resolution at the time of recording is also known (refer to JP-A-2005-33303, for example).

In the image surveillance system, a motion is generally detected by using the images that are acquired from the images inputted from cameras in a predetermined interval and when detected, the motion is finely grasped. To improve accuracy of analysis of the event, the frame rate of the image is preferably changeable so that acquisition frequency of the image frame can be increased, whenever necessary, and an image having high minuteness can be obtained.

From the viewpoint of the efficient operation of the storage medium described above, the frame rate is preferably low but when the frame rate is low, an article having a high moving speed becomes a coarse image because the moving distance between the frames is great. In this case, appropriate tracking is not possible and confirmation of the image content becomes difficult. At this time, image processing for keeping a background image may be necessary depending on conditions. If a drastic illumination change occurs at this time in the image, the background image must be immediately updated unless otherwise a false positive may occur. Therefore, the frame rate is preferably increased as a measure in these cases, too.

When the face of a specific person is assumed to be the event, a processing for segmenting a region containing the image of the face in the frame image becomes necessary. In this case, the best shot screen representing the front of the face is desirable but when the frame rate is low at this time, the frame containing the best shot is likely to fall off. Therefore, a counter-measure by increasing the frame rate is preferably employed in this case.

It will be hereby assumed that the event detected by the image processing in a certain input image among the images taken by a plurality of cameras is judged as an important image set by a surveillance system. In this case, the related technology described above teaches to merely increase the frame rate for recording this input image or to record the image as a high resolution image. Therefore, the related technology is not free from the following problem.

In any surveillance system, the image frame that can be processed in a unit time is of course determined by the scale or specification of the processing resources. Moreover, a plurality of camera inputs must be processed under the limited processing resources of the video recorder and player in the case of the surveillance system as described above. When the processing is executed by making only the frame interval of a certain camera input dense to increase the frame rate of this camera and to improve detection accuracy, the processing of other camera inputs is unavoidably affected.

Since the related technology simply acquires the input image as the object at a high frame rate and executes the processing at this time, a drop frame occurs in the detection processing in other camera inputs. In consequence, accurate event detection is impeded or an excessive load is applied to other processing tasks inside the system.

### SUMMARY OF THE INVENTION

It is an object of the invention to provide a video recorder and player that can accurately detect an event under limited processing resources and limited storage capacity.

The object described above can be accomplished by a video recorder and player for acquiring image data from a plurality of cameras and storing the image data in recording media, including a frame switching unit for switching the plurality of cameras in a predetermined sequence and acquiring image data from each of the cameras at a predetermined frame rate; an image processing unit for detecting an event set in advance from the image data acquired from each of the cameras; and a frame rate changing unit for changing the frame rate of the image data from which the event is detected; the video recorder and player comprising a first unit for changing only the frame rate of the image data from which the event is detected, when the event is detected; a second unit for changing both frame rate of the image data from which the event is detected and frame rate of other image data, when the event is detected; and a third unit for changing the frame rate of other image data within a range in which a possible obstacle is as small as possible, when the event is detected, and for changing as much the frame rate of the image data from which the event is detected; wherein the frame rate changing unit selects a processing by the first unit when the frame rate of the image data from which the event is detected is changeable, even when the frame rate of the image data other than the image data from which the event is detected is not changed; the frame rate changing unit selects a processing by the second unit when the image data for which no obstacle occurs even when the frame rate is lowered exists in the image data other than the image data from which the event is detected; and the frame rate changing unit selects a processing by the third unit when a counter-measure is not possible even when the frame rate of the image data other than the image data from which the event is detected is changed.

In this case, the event may be any of a predetermined motion and a predetermined article (such as the face of a person, a doubtful action, a car, desertion, etc).

The video recorder and player may further include a unit for setting in advance a degree of importance of each event, and the frame rate changing unit preferentially executes changing of the frame rate of the image data in accordance with the degree of importance of the event of each image data when the event occurs in a plurality of image data.

At this time, the degree of importance of the event may be set by a user. When the frame rate of the image data is changed, the frame rate changing unit described above may change also an image compression ratio when the image data is acquired from each camera.

The video recorder and player may further comprise network transmission control unit, and the frame rate changing unit may change a transmission rate by the network transmission control unit, too, when the frame rate of the image data is changed.

According to the invention, it is possible to detect an event by using image processing from images of a plurality of camera units and to distribute a frame rate of the image processing in accordance with the degree of importance of the event. Consequently, the frame rate can be dynamically changed among the camera inputs and the image processing can be accurately executed for a plurality of camera inputs under limited processing resources.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing a video recorder and player according to an embodiment of the invention;

FIG. 2A is a detailed block diagram of input switching unit according to the embodiment of the invention;

FIG. 2B is a schematic view showing an example of a frame;

FIG. 3 is a detailed block view of an image processing unit according to the embodiment of the invention;

FIG. 4 is a detailed block view of an event detection unit according to the embodiment of the invention;

FIG. 5 is a flowchart useful for explaining an operation of frame rate changing unit according to the embodiment of the invention;

FIG. 6 is an explanatory view useful for explaining a frame rate changing processing according to the embodiment of the invention;

FIG. 7 is an explanatory view showing an example of GUI screen display according to the embodiment of the invention;

FIG. 8 is a block diagram when an image compression change is applied to the image processing unit according to the embodiment of the invention; and

FIG. 9 is a block diagram when network transfer is applied to the video recorder and player according to the invention.

### DESCRIPTION OF THE EMBODIMENTS

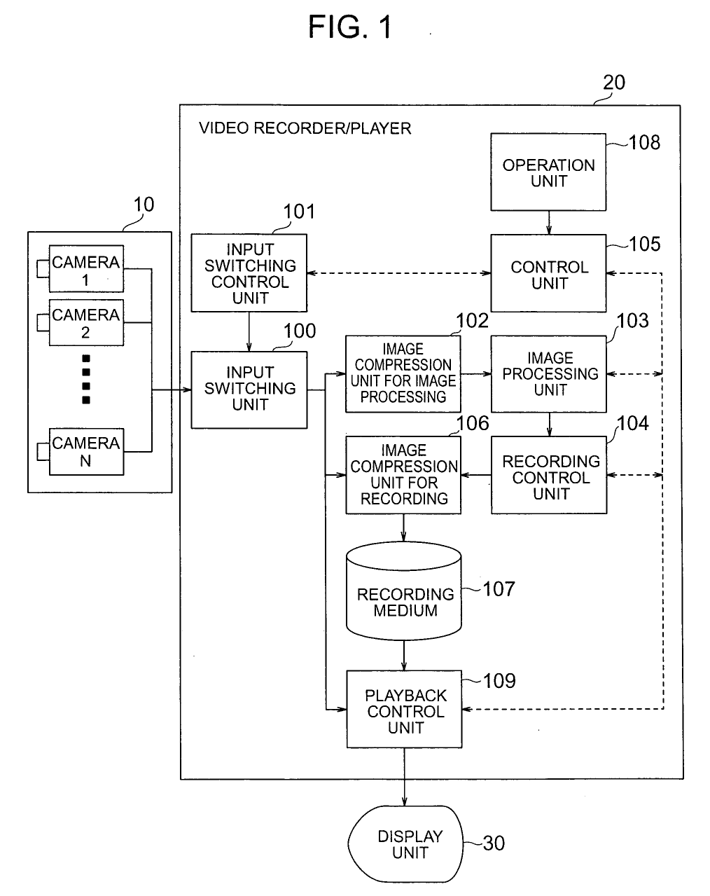

A video recording and playing method and an apparatus for the method according to the invention will be explained in detail with reference to the accompanying drawings. FIG. 1 shows an image capturing unit 10 and a video recorder and player 20 as an embodiment of the invention when the invention is applied to a surveillance system having a plurality of sets of cameras. In this case, a plurality of sets of cameras using a CCD device, for example, that is, N sets of cameras 1 to N, are provided for monitoring to the image capturing unit 10.

Here, the video recorder and player 20 acquires video signals from the N sets of cameras of the image capturing unit 10 and records image information with other information. To confirm the input video image as a live image or to confirm the recorded video data by playback, a display device 30 is connected to the video recorder and player 20 so that the image can be confirmed, whenever necessary.

The processing by the video recorder and player according to this embodiment can be broadly classified into a processing of an image processing system, a processing of a recording system and a processing of a control system and a playback system. Each of these processing will be hereinafter explained serially.

To begin with, the processing flow of the image processing system will be explained. In this case, the signal from each monitor camera of the image capturing unit 10 is inputted to an input switching unit 100, where the signals are selected in accordance with a predetermined sequence and a frame rate, and the image is switched. At this time, an input switching control unit 101 controls switching of the input image in the input switching unit 100. The image signals selected by the input switching unit 100 are supplied to an image compression unit 102 for image processing.

In this image compression unit 102 for image processing, the image compression processing is executed to facilitate the subsequent image processing and to shorten the processing time. The image signals so processed are transmitted to an image processing unit 103, where event detection to be described later is executed and motion inside the image is detected. The processing result is transmitted to a recording control unit 104. The operation of the image processing unit 103 at this time is controlled by a control unit 105.

Next, the processing flow of the recording system will be explained. In this case, the image signals selected by the input switching unit 100 are supplied to an image compression unit 102 for image processing and are further supplied to an image compression unit 106 for recording. The image compression unit 106 for recording compresses the image data by a known compression coding method such as MPEG and JPEG. After information about an event such as date, event, motion, face, doubtful action, car, desertion, etc, is added, the information is transmitted to, and stored and preserved in, a storage medium 107.

Control of the image compression unit 106 for recording is made by the control unit 105 in the same way as the image processing unit 103 described above but in this case, control is made through the recording control unit 104. The recording control unit 104 individually controls the recording frame rate and image quality in the image compression unit 106 for recording for the input of each camera. Furthermore, when the event such as the motion occurs owing to the image processing described above, control is so made as to start recording and to change image quality.

Next, the processing flow of the control system as well as the playback system will be explained. First, an operation unit 108 inclusive of GUI (Graphical User Interface) and apparatus buttons is provided to the video recorder and player 20 and a user can make various kinds of setting to the video recorder and player 20. The set data by the operation unit 108 is inputted to the control unit 105 and is from thence transmitted to the input switching control unit 101, the image processing unit 103, the recording control unit 104 and the playback control unit 109.

On the other hand, those kinds of information which are generated by the input switching control unit 101, the image processing unit 103, the recording control unit 104 and the playback control unit 109 and are to be supplied to other control units are supplied from these units to the control unit 105, on the contrary, and are transmitted to the corresponding destinations through them. During the playback processing, the live image and the recording data are played back on the basis of the setting by the control unit 105 and are displayed by the display device 30.

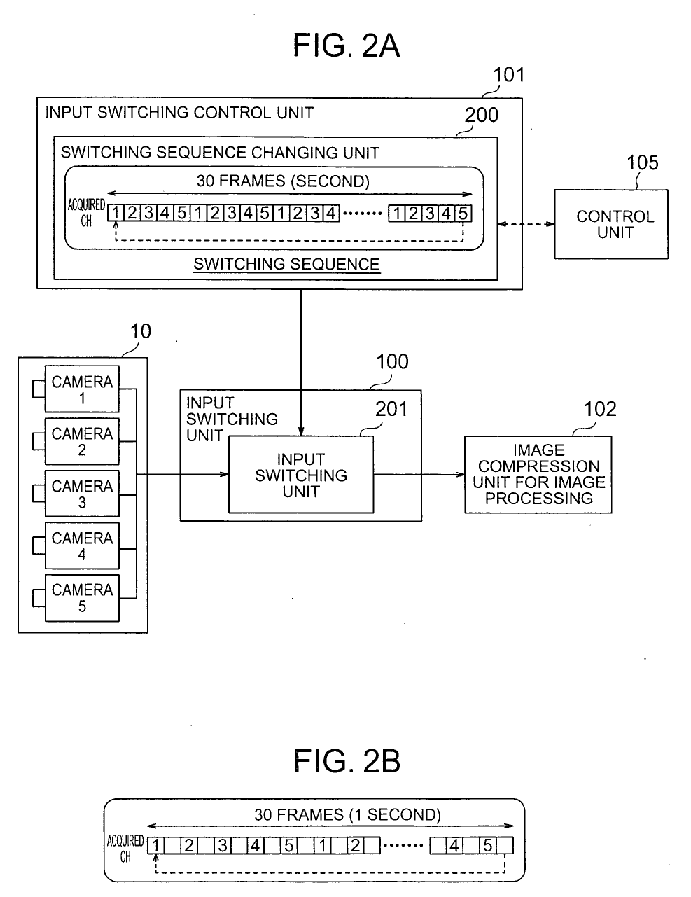

Here, the processing by the input switching unit 100 will be explained about the image processing system inclusive of its peripheral portions with reference to FIGS. 2A and 2B by way of example. A switching sequence changing unit 200 is provided to the input switching control unit 101 as shown in the drawing. It will be hereby assumed that a frame rate for the image processing is set to 30 fps (frames per second) by the control unit 105. The switching sequence changing unit 200 generates a permutation for switching within a predetermined frame on the basis of the frame rate so set, and supplies it to the input switching unit 100.

The explanation will be hereby given about the case where N is 5, for example, in the imaging unit 10 shown in FIG. 1, that is, about the case where 5 sets of cameras are used. In this case, the permutation generated by the switching sequence changing means 200 is the one in which five inputs are switched per second and equidistantly move from the camera 1 to the camera 5 as shown in FIG. 2A. Consequently, each input provides an input of the frame rate of 6 fps. On the other hand, FIG. 2B represents the example where a one-frame interval is secured for switching. It can be appreciated that the input becomes an input of a 3 fps frame rate.

Therefore, the input switching unit 201 provided to the input switching unit 100 executes the switching processing of the camera input in accordance with the permutation generated by the switching sequence changing unit 200 so that the selected input image can be transferred to the image compression unit 102 for image processing. Incidentally, this switching of the input is executed similarly in the processing of the recording system and the playback system as will be explained later.

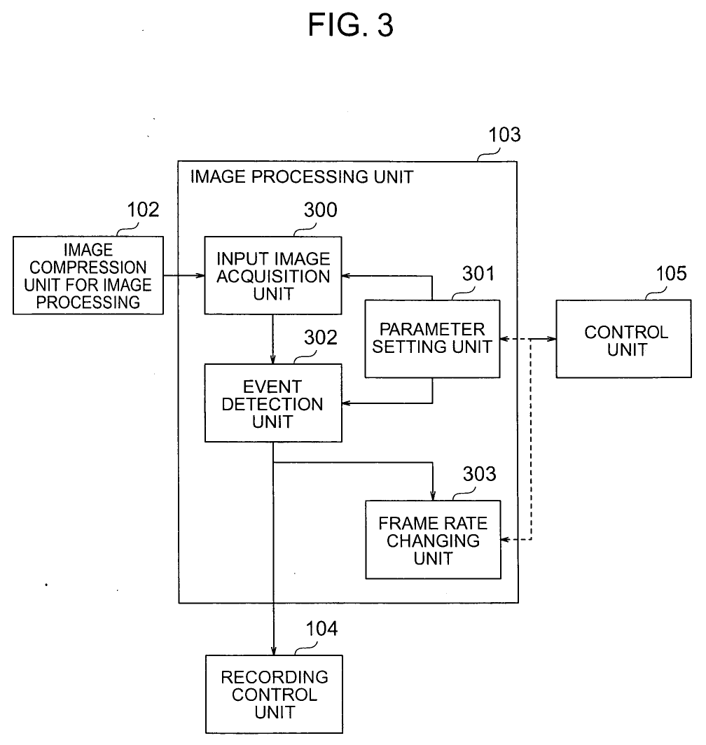

Next, the processing of the image processing unit 103 will be explained with reference to FIG. 3. In this case, the input image acquisition unit 300 acquires the image data compressed for the image processing from the image compression unit 102 for processing and transfers the image data to the event detection unit 302. At this time, parameters for image processing are set by a parameter setting unit 301 on the basis of the information transferred from the control unit 105.

The result detected by the event detection unit 302 is transmitted to both frame rate changing unit 303 and recording control unit 104. The frame rate of each input changed by the frame rate changing unit 303 is supplied to the input switching control unit 101 through the control unit 105 and is utilized for changing the switching permutation.

Next, the detail of each processing in the image processing unit 103 will be explained. In this embodiment, the case where a background differential method is applied to the event detection processing in the event detection unit 302 will be explained, by way of example. In this case, the event is regarded as occurring when partial motion is detected inside the image. Therefore, detection of the motion at this time is based on the premise that a background image is retained for comparing with the input image.

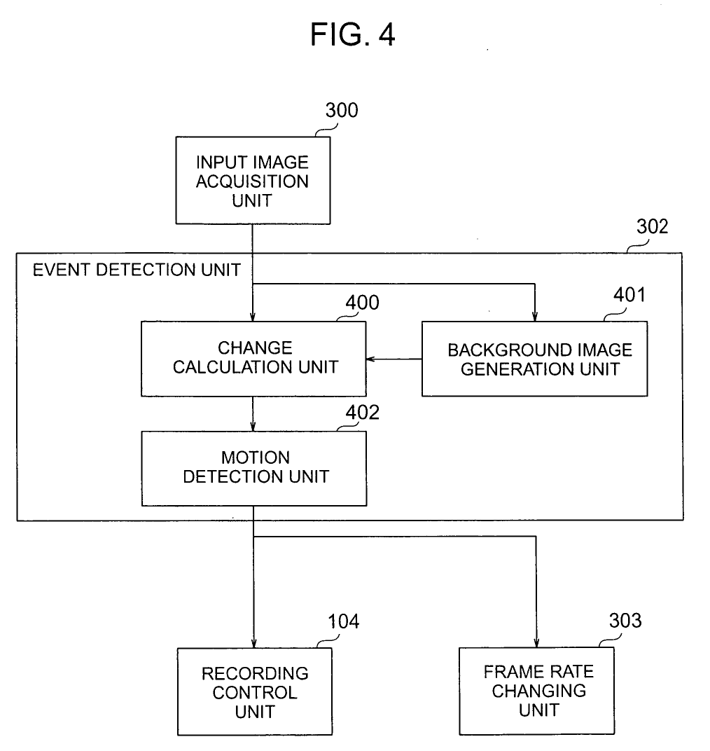

Here, the term “background image” represents an image of a region not containing a moving article inside the input image and the term “background differential method” represents a method that detects a portion having a change with respect to the background image by comparing the input image and the background image, regards the detected portion as the motion of the image and regards it as the moving article such as people. The case where this method is applied to the event detection unit 302 will be explained with reference to FIG. 4.

Referring to FIG. 4, a background image generation unit 401 generates in advance the background image from the image acquired from the input image acquisition unit 300 and holds this image. In this case, it is possible to use either a method that merely sets portions not having motion as the background image or a method that generates the background image from the time series of the input images. A change calculation unit 400 compares the background image with the input image and supplies the comparison result to a motion detection unit 402 to judge whether or not it is the motion corresponding to the event. The judgment result is transmitted to the recording control unit 104 and to the frame rate changing unit 303.

Those motions which result in various events can be set from the control unit 105 to the motion detection unit 402 through the parameter setting unit 301 as will be described later in detail. Any motions can be set as the events such as faces of persons (inclusive of the face of a specific person), cars, persons moving in specific routes, persons having attributes such as specific clothes and sex, persons committing crime or playing doubtful actions, goods deserted, and so forth, as long as they can be detected by the image processing.

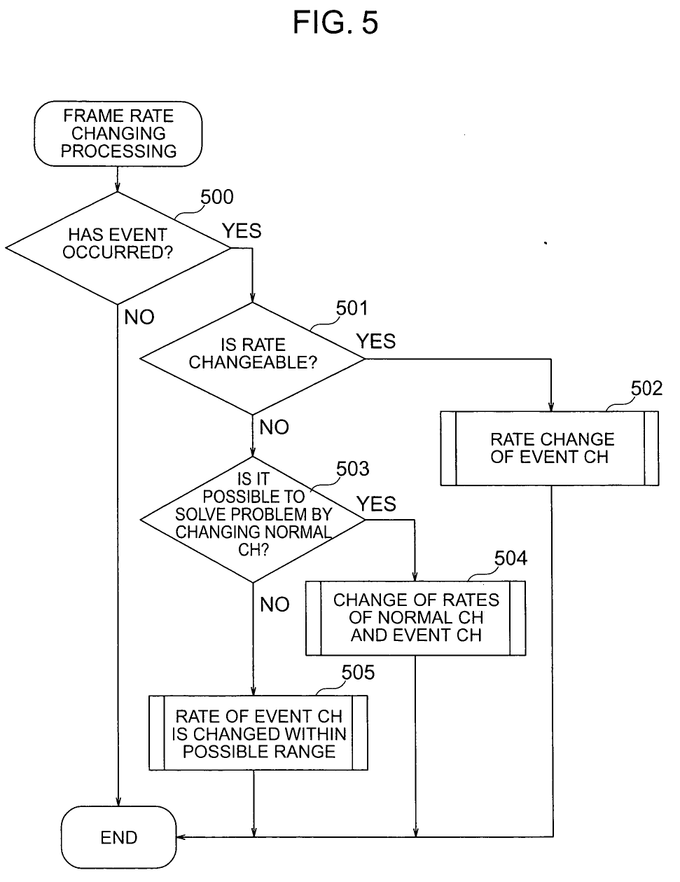

Next, the processing by the frame rate changing unit 303 will be explained with reference to the flowchart showing the basic processing in FIG. 5. First, the state in which no event is judged as existing is regarded as the normal state and the camera input corresponding to this normal state is regarded as a normal CH (channel). Next, the state in which an event occurs is regarded as an event state and the camera input corresponding to the event state is regarded as an invent CH. Here, the frame rate under the normal state is a predetermined rate such as 6 fps described above.

The processing for increasing the frame rate of a certain camera input when an event owing to the motion of a person is detected in this camera input in FIG. 5 will be explained, by way of example. First, when the judgment result in step 500 is Y (positive), that is, when the event is judged as occurring, the state of all inputs is confirmed in step 501 and whether or not the change of the frame rate of the corresponding CH is possible is merely judged. The judgment at this time may be executed by judging whether or not any margin exists in the processing resource.

When the change of the frame rate is possible without changing the frame rate of other ordinary CH because the processing resources have a margin or for some other reasons, that is, when the result is Y in step 501, the flow proceeds to step 502 and the frame rate of the event CH is increased from the frame rate of the normal state to the frame rate corresponding to the predetermined event at this time. The processing is then completed.

Therefore, the frame rate of the event CH is simply increased at this time but accuracy of the event analysis of the event CH can be improved without affecting the normal CH.

When the result in step 501 is N (negation), that is, when the frame rate change is judged as impossible, on the other hand, the flow proceeds to step 503 and whether or not the change of the frame rate of the event CH is possible by changing the frame rate of the normal CH is judged at this time. Here, a certain CH exists among the normal CH which renders no problem even when its frame rate is lowered. Therefore, whether or not the frame rate of the event CH can be increased if the frame rate of this normal CH is lowered is judged. When this is possible, that is, when the judgment result is Y, the flow proceeds to step 504, where the frame rate of the normal CH is lowered and the frame rate is increased as required for the event CH. The processing is then completed.

Therefore, the frame rate of the event CH is increased at this time, too, and the frame rate is lowered for a part of the normal CH. However, because those normal CH are originally selected which are a little affected by lowering the frame rate, the improvement of event analysis accuracy of the event CH does not affect the processing of the normal CH.

On the other hand, when the judgment result in step 503 is N, that is, when the change of the frame rate of the normal CH does not suffice, the flow proceeds to step 505, where the frame rate of the normal CH is lowered within the range in which the possible problem is as small as possible, and the frame rate of the event CH is increased as much and the processing is completed.

Therefore, the improvement in accuracy of the event analysis of the event CH results in the drop of the frame rate of other normal CH but in this case, too, the drop of the frame rate can be limited to the range where the drop is as small as possible.

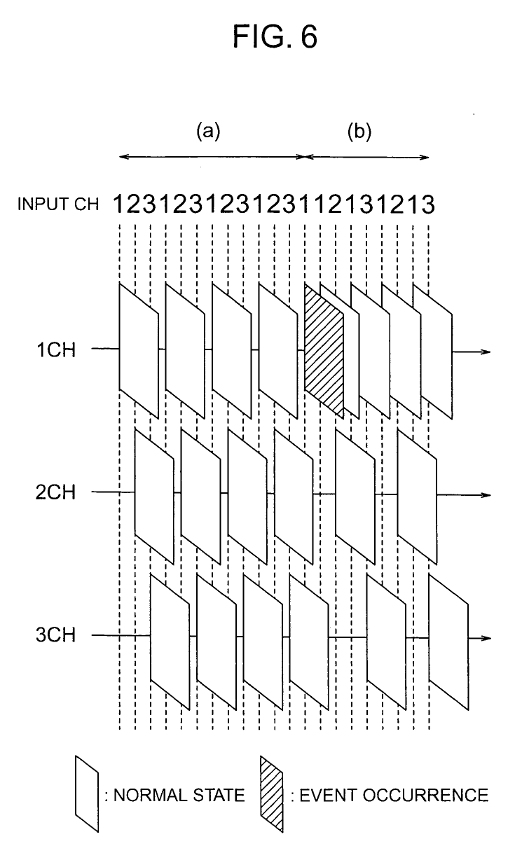

As described above, the frame rate calculated by the frame rate changing unit 303 is supplied to the input switching control unit 101 through the control unit 105 and is applied to the change control of the switching permutation by the input switching unit 100. The change of the frame rate at this time will be explained with reference to a schematic view of FIG. 6.

FIG. 6 shows the switching operation of the frame rate when the processing of step 504 or step 505 in FIG. 5 is executed provided that the number of cameras of the image capturing unit 10 is 3 and the camera input is 3 channels of 1CH, 2CH and 3CH. Under the normal state shown in (a) of FIG. 6, the input is serially switched for each frame in each channel.

It will be assumed hereby that an event occurs in the 1CH, then the operation state changes at this point to an event occurrence state shown in (b) of FIG. 6, and the frame rate is lowered between the 2CH and 3 CH. Because the frame is thinned out by this lowering of the frame rate, the frame of the 1CH is inserted into this time position, so that the frame rate of the 1CH is increased. The operation state thereafter returns to the normal state shown in (a) of FIG. 6 at the point of time when the event detection is completed.

Incidentally, when a plurality of channels in which events occur simultaneously occurs, it is not possible in some cases to apply the processing for increasing the frame rate to all these channels. In this embodiment, therefore, a predetermined rule prescribing to which channel the switching processing of the frame rate is to be applied is employed.

The predetermined rule used at this time gives priority for increasing the frame rate to a channel having a higher degree of importance of the occurring event. The processing for this object is given by the frame rate changing unit 303. Furthermore, the user can select either to change the frame rate or to keep it fixed for each channel.

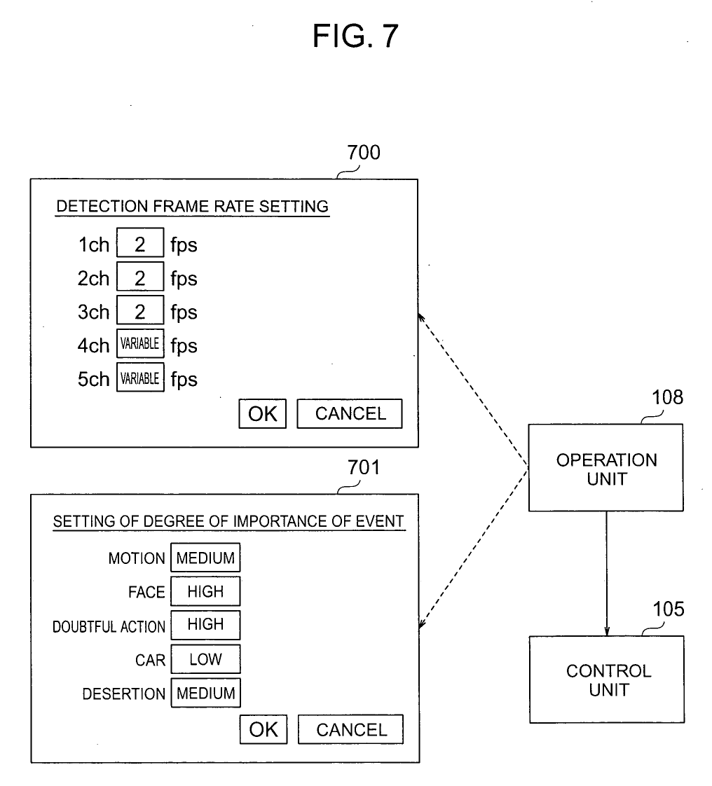

Here, this arrangement will be explained with reference to FIG. 7. First, the user executes frame rate setting and event importance setting. Therefore, the operation unit 108 has a detection frame rate setting window 700 and an event importance setting window 701 as shown in the drawing.

Frame rate setting is made for each camera input on the detection frame rate setting window 700 in such a fashion that the frame rate is a fixed value or a variable value for each channel. When the fixed value is hereby selected, the frame rate is fixed to the predetermined frame rate set and when the variable value, the frame rate changing processing described above is applied so that the frame rate can be dynamically changed depending on the detection condition of the event.

In the example shown in FIG. 7, 1CH to 3CH are fixed at 2 fps and the variable frame rate is selected for 4CH and 5CH. In this case, 6 fps as the sum of the frame rates of 1CH to 3CH is subtracted from 30 fps as the frame rate that can be processed as a whole, and the frame rates of 4CH and 5CH are dynamically changed in the remaining 24 fps.

On the event importance setting screen 701 shown in FIG. 7, importance about the content of the motion inside the image is defined as the degree of importance of the event. In the example shown in FIG. 7, five kinds of events, i.e. motion of a subject, its face, a doubtful action, a car and desertion, are set in advance as the event and the user can set the degree of importance of each event to three stages of low, medium and high. Here, the face and the doubtful action have a high degree of importance, the motion and desertion have a medium level and the car has a low degree of importance.

The frame rate changing unit 303 decides the channels the frame rate of which is to be changed, on the basis of the degree of importance set when the event detection unit 302 detects the occurrence of the event in a plurality of channels.

When a doubtful action is detected by a certain camera input and a car is detected by another camera input, the frame rate change is preferentially applied to the camera input detecting the doubtful action because the higher degree of importance is set to the doubtful action, and the images are recorded at the higher frame rate.

According to this embodiment, therefore, the image processing corresponding to the degree of importance of the event becomes possible. As a result, event analysis having higher accuracy can be acquired with limited processing resources and the monitor result having high reliability can be acquired while effective utilization of the processing resources and the recording medium is sufficiently achieved.

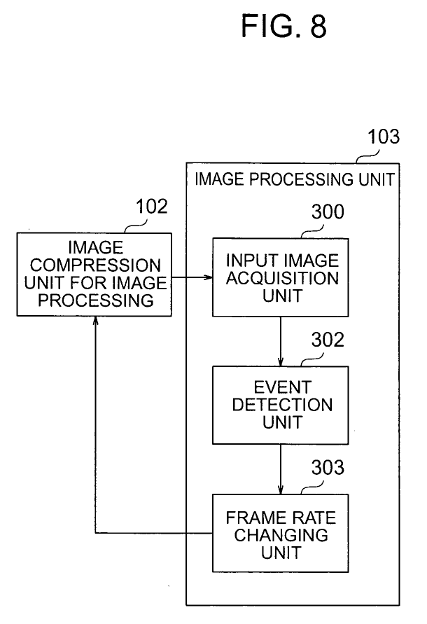

In the embodiment explained above, the change of the frame rate has been the center of the image processing. However, it is also possible to constitute the image processing unit 103 into the construction shown in FIG. 8 so that the change result of the frame rate by the frame rate changing unit 303 can be transmitted to the image compression unit 102 for image processing, too, and the compression ratio of the images can be changed in accordance with the change of the frame rate.

In the case of the embodiment shown in FIG. 8, the compression ratio of the images may be lowered when the event is detected and in this way, the drop of resolution of the images due to image data compression can be suppressed and image processing can be acquired with higher accuracy.

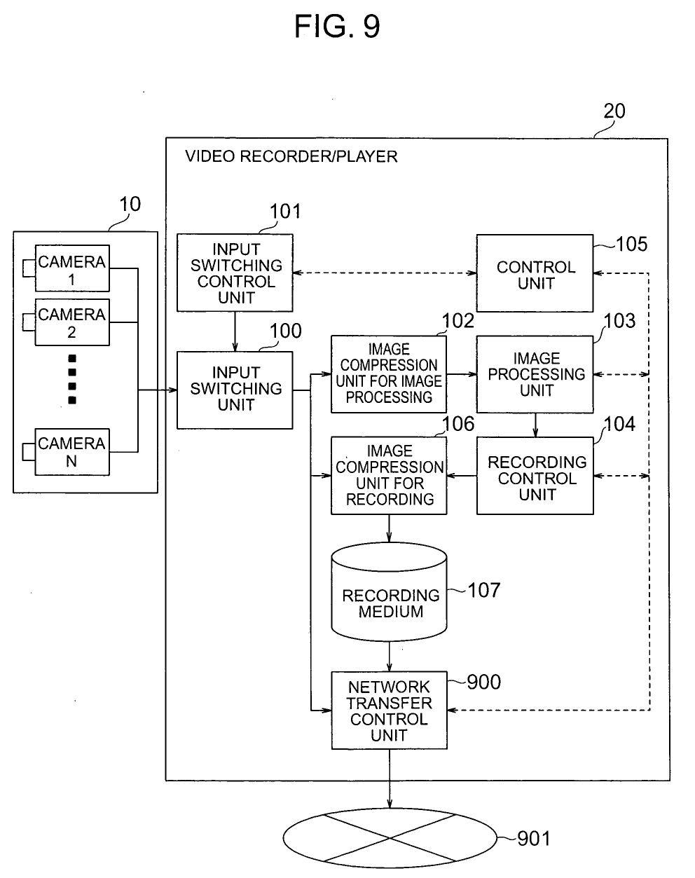

FIG. 9 shows another embodiment of the invention, where the change information of the frame rate is utilized for the control of network transmission. In this case, a network transmission control unit 900 is disposed in place of the playback control unit 109 in the embodiment shown in FIG. 1 and the result determined by the frame rate changing unit 303 is transmitted to this network transmission control unit 900. When the images are transmitted through a network 901, images having a higher degree of importance are transmitted at a higher frame rate and normal images are transmitted at a lower frame rate.

Effective utilization of a transmission band is of course desirable because the transmission band is limited in the transmission through the network. Effective utilization of the band can be achieved when the images that are believed important are transmitted at a high frame rate and the normal images are transmitted at a low frame rate as in this embodiment. As a result, the important images inclusive of the image containing an intruder can be preferentially transmitted to the network 901. In consequence, this embodiment can suppress the occurrence of leak of confirmation and can further improve reliability.

The embodiment shown in FIG. 9 can be applied to the case where the images are captured by a network camera through the network 901 and the image processing is executed for such images. At this time, the important images and the normal images can be assorted at an appropriate ratio by using the frame rate changing unit of this embodiment and the images can be reliably transmitted even when the transmission band of the network 901 is limited.

It should be further understood by those skilled in the art that although the foregoing description has been made on embodiments of the invention, the invention is not limited thereto and various changes and modifications may be made without departing from the spirit of the invention and the scope of the appended claims.

1. A video recorder/player for acquiring image data from a plurality of cameras and storing the image data in recording media, including:
a frame switcher for switching said plurality of cameras in a predetermined sequence and acquiring image data from each of said cameras at a predetermined frame rate;
an image processor for detecting an event set in advance from said image data acquired from each of said cameras; and
frame rate changing means for changing the frame rate of the image date from which the event is detected;
said video recorder/player comprising:
first means for changing only the frame rate of the image data from which the event is detected, when the event is detected;
second means for changing both frame rate of the image data from which the event is detected and frame rate of other image data, when the event is detected; and
third means for changing the frame rate of other image data within a range in which a possible obstacle is as small as possible, when the event is detected, and for changing as much the frame rate of the image data from which the event is detected; wherein:
said frame rate changing means selects a processing by said first means when the frame rate of the image data from which the event is detected is changeable, even when the frame rate of the image data other than the image data from which the event is detected is not changed;
said frame rate changing means selects a processing by said second means when the image data for which no obstacle occurs even when the frame rate is lowered exists in the image data other than the image data from which the event is detected; and
said frame rate changing means selects a processing by said third means when a counter-measure is not possible even when the frame rate of the image data other than the image data from which the event is detected is changed.

2. A video recorder/player according to claim 1, wherein said event is at least one of predetermined actions and articles such as motion of a subject, a face of a person, a doubtful action, a car and desertion.

3. A video recorder/player according to claim 1, which further comprises means for setting in advance a degree of importance of each event, and wherein said frame rate changing means preferentially executes the change of the frame rate of the image data in accordance with the degree of importance of the event of each image data when the event occurs in a plurality of image data.

4. A video recorder/player according to claim 3, wherein the degree of importance of the event is set by a user.

5. A video recorder/player according to claim 1, wherein said frame rate changing means changes an image compression ratio, too, at the time of acquisition of the image data when the frame rate of the image data is changed.

6. A video recorder/player according to claim 1, which further comprises network transmission control means, and wherein said frame rate changing means changes a transmission rate by said network transmission control means, when the frame rate of the image data is changed.
